(19) United States
(12) Patent Application Publication
(10) Pub. No.: US 2007/0019529 A1
(43) Pub. Date: Jan. 25, 2007

(54) METHOD AND CONTROL SYSTEM FOR OUTPUT POWER CONTROL THROUGH DYNAMICALLY ADJUSTING RELATIONSHIP BETWEEN OUTPUT POWER AND CONTROL VALUE

(76) Inventor: Hsu-Feng Ho, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/161,070

(22) Filed: Jul. 21, 2005

(51) Int. Cl. G11B 7/00

(52) U.S. Cl. 369/116

(57) ABSTRACT

A control method and a control system of output power control for a laser diode. The method includes utilizing a first test control signal for driving the laser diode to generate a first laser beam, detecting power of the first laser beam for generating a first detecting signal, utilizing a second test control signal for driving the laser diode to generate a second laser beam, detecting power of the second laser beam for generating a second detecting signal, determining a relationship between output power of the laser diode and a driving signal according to the first and second test control signals and the first and second detecting signals, and controlling output power of the laser diode according to the relationship. The control system includes at least a driving circuit, a sensor, and an estimator to perform the above steps.

### BACKGROUND

The present invention relates to a method and system for controlling output power of a laser diode, and more specifically, to a method and control system with optimal output power control for a laser diode by dynamically adjusting a relationship between the laser power and the control value.

With the improvement of computer technologies and the increasing popularity of the Internet, the optical disc drive is increasingly important in our daily life. For example, users can access an abundance of information by connecting a computer to the Internet and then storing all of the downloaded information onto optical discs. Since the optical disc has the advantages of a large storage capacity, compactness, and is inexpensive, optical disc-related products have become diversified and important. Taking a CD-RW drive for example, it not only reads data from a CD-RW disc but also rewrites the data onto the disc. Moreover, another optical disc called the digital versatile disc (DVD) becomes more and more popular. The DVD is capable of providing much larger capacity but still while maintaining the same physical size as a CD disc. The optical disc drive, therefore, has become popular equipment in our life.

The optical disc drive accesses data according to optical means, that is, the reading and writing operations depend on a pick-up head, which commonly includes a laser diode for reading data or a set of laser diodes for reading and writing data. With respect to the reading process, the optical disc drive sets the output power (also known as the read power) of a laser diode to a desired value. Next, the optical disc drive detects reflected laser from an optical disc to read the data stored on the optical disc. It is well known that the optical disc stores the data utilizing pits and lands. This allows the optical disc drive to access the data stored on the optical disc by distinguish a plurality of different wavelengths of reflected laser that are generated from the pits and the lands. With respect to the writing process, the optical disc drive properly sets the output power (also known as the write power) of the laser diode according to the data waiting to be written onto the optical disc. As mentioned above, for reading data from the optical disc or recording data onto the optical disc, the procedure for properly adjusting output power of the laser diode is an important issue.

Please refer to FIG. 1. FIG. 1 is a diagram illustrating the relationship between the output power of a laser diode and a driving current. As the curve 5 shows, the diode is unable to emit a laser beam when the driving current is below the threshold value lₜₕ. When the driving current is over the threshold value Iₜₕ, the laser diode will begin emitting a laser beam and the power of the laser beam will almost be in proportion to the magnitude of the driving current. Unfortunately, temperature variation can influence the curve 5 described above. As the operation temperature of the laser diode increases, the relationship between output power of the laser diode and the driving current also changes. As shown in FIG. 1, the curve 5 represents the relationship under temperature T₁, and the other curve 5′ represents the relationship under temperature T₂, where T₂ is higher than T₁. As illustrated by FIG. 1, a greater driving current is needed to make the laser diode outputting a laser beam with the same power when the operation temperature is increasing. However, the conventional power control method for the pick-up head of the optical disc drive typically not focuses on the effects of temperature to avoid incurring additionally monetary cost associated with manufacturing the optical disc drive. In other words, the conventional power control method considers the operation temperature effect described above with other parameters together and deals with this problem via a simply closed loop, it usually causes a long response time. The additional cost would be incurred because the designer has to build additional hardware to handle the power offset caused by temperature variation. As a result, when the operation temperature of the laser diode changes, the conventional power control method has to adjust output power of the pick-up head through applying a conventional close-loop circuit. It cannot response the influence of operation temperature immediately and dynamically.

Please refer to FIG. 2. FIG. 2 is a block diagram of a power control loop 10 according to the related art. The related art, power control loop 10, is built into an optical disc drive for stabilizing the output power via a feedback mechanism. The power control loop 10 comprises a driving circuit 20, an integrator 30, a sensor 40, and a laser diode 50. The driving circuit 20 is electrically connected to the laser diode 50 and drives the laser diode 50 to emit a laser beam L being proportion to a driving signal S_{d} (e.g., a driving voltage or a driving current). The driving circuit 20 is usually simply constructed by a resistor 60, and S_{d}, the driving signal, can be determined easily through the resistance of the resistor 60. The sensor 40 is typically referred to as a front monitor diode (FMD) or front photodiode (FPD). The FMD or FPD detects the power of the laser beam L generated from the laser diode 50 and generates a detecting signal Sₐ. The detecting signal Sₐ is typically referred to as a front photodiode output (FPDO) signal.

The integrator 30 compares the detecting signal Sₐ with a reference signal S_{b}. Reference signal S_{b} is provided by the system, and represents the expected value of the detecting signal Sₐ, where the expected value of the detecting signal Sₐ means a value of Sₐ that is corresponding to a target power of the laser diode 50. In other words, the laser diode 50 provides the laser beam L with a target power. Ideally, the voltage level of the detecting signal Sₐ will be identical to that of the reference signal S_{b}. It is well known that the integrator 30 includes an operation amplifier 70, two resistors 80,100 and a capacitor 90. The output end of the integrator 30 is electrically connected to the driving circuit 20 for transmitting a control signal S_{c} to the driving circuit 20. If output power of the laser diode 50 is less than the target power, the control signal S_{c} outputted from the integrator 30 will cause the driving circuit 20 to increase the driving signal S_{d}. If output power of the laser diode 50 is greater than the target power, the control signal S_{c} outputted from the integrator 30 will cause the driving circuit 20 to decrease the driving signal S_{d}.

As mentioned above, the relationship between the driving signal S_{d} and power of the laser diode 50 changes as the operation temperature of the laser diode 50 varies. Please refer to FIG. 2 and FIG. 3. FIG. 3 is a diagram illustrating the relationship between the front photodiode output (the driving signal S_{d}) and laser power according to the related art. As curve 110 shows, the front photodiode output (the driving signal S_{d}) is proportional to laser power, and the curve 110 not shifts when the operation temperature varies. As a result, when the operation temperature varies, the detecting signal Sₐ changes with the operation temperature due to power of the laser diode 50 changes with the operation temperature, as shown in FIG. 1. In a conventional closed loop as FIG. 2 shows, it utilizes the integrator 30 to fix this problem, usually takes much time. Therefore, the related art power control loop 10 is unable to efficiently compensate the driving signal S_{d} for the power offset caused by a variation in temperature. As a result, the performance of the optical disc drive is decreased.

In addition, the power control loop 10 shown in FIG. 2 is an analog circuit utilizing capacitors to hold the control values (e.g., control voltages). However, the optical disc drive might pause for a short period while performing data recording, and then resume recording the remaining data. In the event of a pause, and because the capacitor discharges due to the leakage current, the control value at the time when the data recording is paused is different from the control value at the time when the data recording is resumed. Therefore, it is a disadvantage of the power control loop 10 to spend additional time adjusting the output power of the laser diode 50 to the target power.

There is another factor has to be considered on manufacturing procedures, due to a pick-up head usually has several channels (such as read channels and write channels) and only one laser diode. It means that the conventional closed power control loop 10 will not be established in all channels. Therefore, the effect caused by temperature variation has to be ignored or be compensated by a fixed value in some channels.

### SUMMARY

It is therefore one of the objectives of the claimed invention to provide a method and control system having optimal output power control for a laser diode by dynamically adjusting a relationship between the output power and the control value, to solve the above-mentioned problems.

According to the claimed invention, a method for optimal output power control of a laser diode is disclosed. The method includes utilizing a first test control signal for driving the laser diode to generate a first laser beam, detecting power of the first laser beam for generating a first detecting signal, utilizing a second test control signal for driving the laser diode to generate a second laser beam, detecting power of the second laser beam for generating a second detecting signal, determining a relationship between output power of the laser diode and a control signal according to the first and second test control signals and the first and second detecting signals, and controlling output power of the laser diode according to the relationship.

According to the claimed invention, a method for optimal output power control of a laser diode is disclosed. The method includes predicting an initial first relationship between output power of the laser diode and a control signal, utilizing a first test control signal determined by the initial first relationship for driving the laser diode to generate a first laser beam, detecting power of the first laser beam for generating a first detecting signal, comparing the first detecting signal with a desired detecting signal to generate a corrective value, determining a first relationship between output power of the laser diode and the control signal according to the initial first relationship and the corrective value, and controlling output power of the laser diode according to the first relationship.

According to the claimed invention, a control system has optimal output power control of the laser diode is disclosed. The control system includes a driving circuit electrically connected to the laser diode for driving the laser diode to generate the first laser beam according to the first test control signal and driving the laser diode to generate the second laser beam according to the second test control signal, a sensor for detecting power of the first laser beam to generate the first detecting signal and detecting power of the second laser beam to generate the second detecting signal, and an estimator electrically connected to the sensor and the driving circuit for determining the first and second test control signals, determining a relationship between output power of the laser diode and the driving signal according to the first and second test control signals and the first and second detecting signals, and controlling output power of the laser diode according to the relationship.

It is an advantage of the claimed invention that the method and control system dynamically estimates the relationship between the laser power and the control value. The offset due to temperature variation is fully considered. In addition, when the reading or writing operations begin for user data, an initial power of a laser diode is very close to a target power with an initial control value predicted through the estimated relationship. This greatly reduces the time needed to stabilize output power of the laser diode.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating the relationship between the output power of a laser diode and a driving current according to the related art.

FIG. 2 is a block diagram of a power control loop according to the related art.

FIG. 3 is a diagram illustrating the relationship between the front photodiode output and laser power according to the related art.

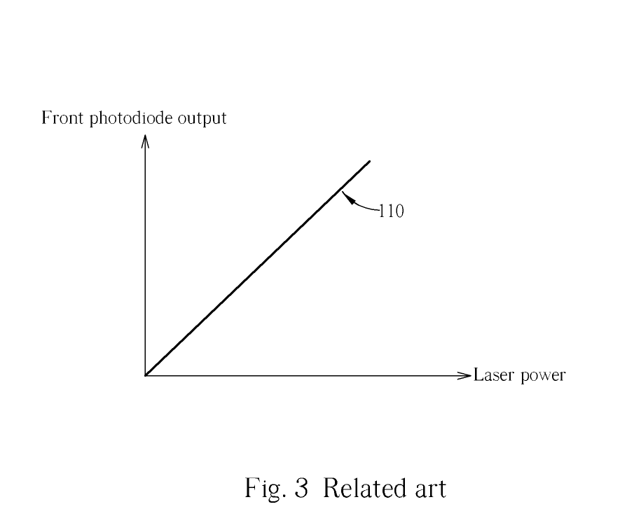

FIG. 4 is a block diagram of a control system according to an embodiment of the present invention.

FIG. 5 is a flowchart illustrated the method to determine the first and second relationship of the embodiment disclosed in the present invention.

FIG. 6 is a flowchart illustrated the method to determine the first relationship of the embodiment disclosed in the present invention.

### DETAILED DESCRIPTION

The present invention, a method and a control system with optimal output power control for a laser diode, aims to immediately and dynamically update the relationship between a driving signal and output power of a laser diode as the environmental parameter changes, for example, the operation temperature unexpectedly varies, or the characteristic of the laser diode deviates from its original setting due to aging.

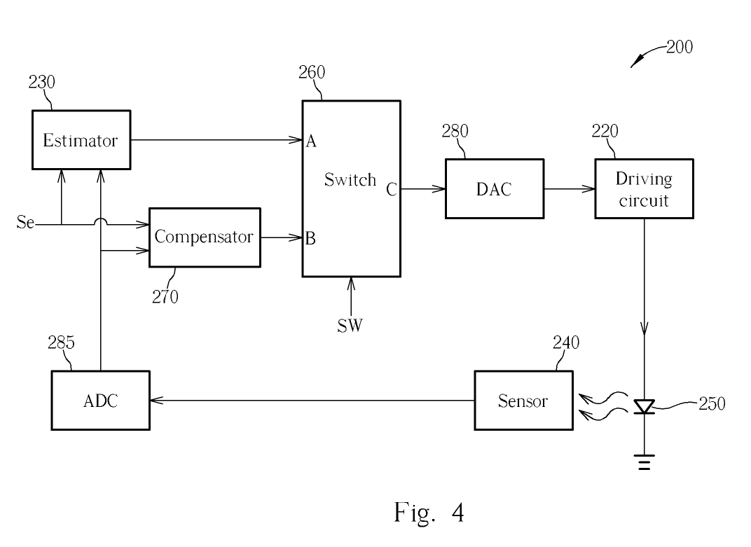

Please refer to FIG. 4. FIG. 4 is a block diagram of a control system 200 according to an embodiment of the present invention. The control system 200 can be applied to many fields, especially to output power control of laser diodes in optical disc drives. For analyzing the control system 200, it is separated into two loops. The first loop includes a driving circuit 220, a laser diode 250, a sensor 240, an analog-to-digital converter (ADC) 285, an estimator 230, a switch 260, and a digital-to-analog converter (DAC) 280; the second loop includes a driving circuit 220, a laser diode 250, a sensor 240, an analog-to-digital converter (ADC) 285, a compensator 270, a switch 260, and a digital-to-analog converter (DAC) 280. The difference between two loops is obviously that the first loop passes through the estimator 230 and the second loop passes through the compensator 270. A control signal SW controls the switch 260 switching to the input port A or the input port B for choosing which loop the control system 200 is followed. The function of control signal Sₑ is similar to the control signal S_{c} discussed in the prior art, it represents a value related to desired output power of the laser diode 250.

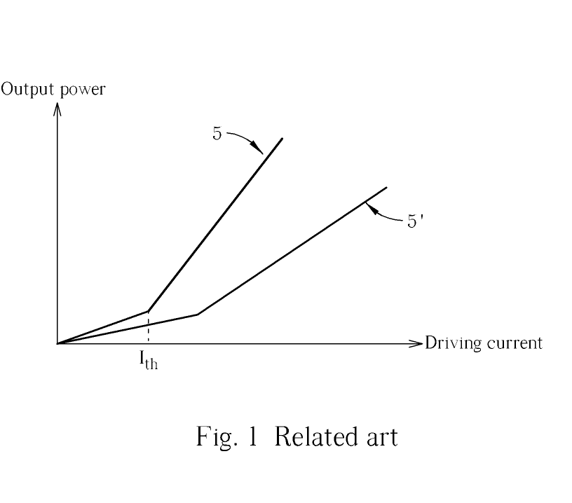

First, paying attention on the first loop, the driving circuit 220 is electrically connected to the laser diode 250 and outputs a driving signal to drive the laser diode 250 to generate a laser beam. Usually, the driving signal is a voltage signal, however, sometimes a current signal is preferred when the laser diode 250 is current-driven. The laser diode 250 is a laser diode generally available on the market, and output power of the laser diode 250 and the driving signal have a relationship like the relationship represented by the curves 5, 5′ shown in FIG. 1. The sensor 240 is utilized to detect power of the laser beam to generate a detecting signal. The sensor 240 is a photodiode. (A photodiode is commonly referred to as a front monitor diode (FMD) or front photodiode (FPD). The detecting signal, in this embodiment, can be either a voltage signal or a current signal, depending on the circuit architecture of the estimator 230. The ADC 285 converts the detecting signal into a detecting value and then transfers the detecting value to the estimator 230.

The estimator 230 is capable of outputting a control value to the switch 260. If the control signal SW switches the input of the switch 260 at input port A, the control value is transmitted to the DAC 280. The DAC 280 further converts the incoming control value into a control signal utilized for controlling the driving signal generated from the driving circuit 220. Similarly, the control signal outputted from the DAC 280 could be a voltage signal or a current signal according to the design requirement. Please note that the estimator 230 also determines a relationship between output power of the laser diode 250 and the control value. After the relationship is properly estimated, the estimator 230 controls output power of the laser diode 250 according to the currently determined relationship. In this embodiment, the estimated relationship includes an offset term and gain term to compensate for the above-mentioned temperature variation. The operation of estimating the relationship is detailed as follows.

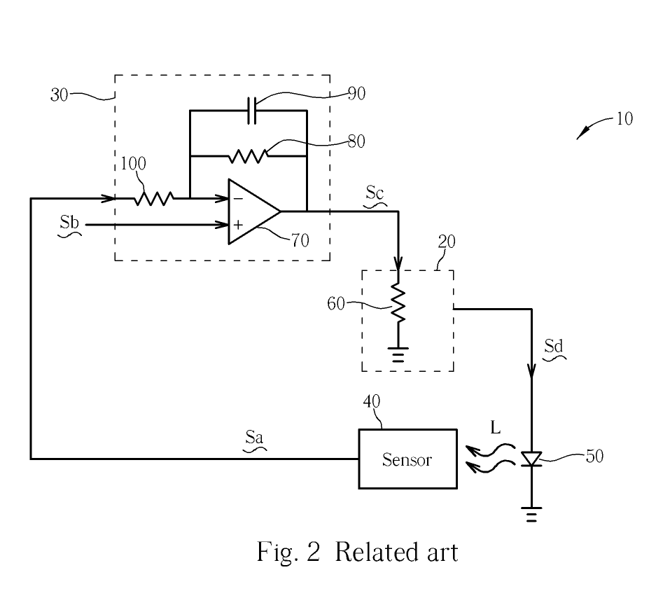

As shown in FIG. 1, the curves 5, 5′ represent the relationship between output power of the laser diode 250 and the driving signal (i.e., driving current). Each of the curves 5, 5′ includes a straight line, which means there is a linear mapping between the output power and the driving signal. Further, the digital-to-analog conversion is linear, and the driving signal is in proportion to the control signal. In addition, the output power is in proportion to the detecting signal as FIG. 2 shows. Therefore, when the laser diode 250 is capable of emitting laser beams, the relationship based on experiment results, could be expressed as the following mathematic model.
S=K₁*D+K₂*T+K₃ eq.(1)

As to eq.(1), S represents the detecting signal outputted from the sensor 240, D represents the driving signal, T represents the operation temperature of the laser diode 250, and K₁-K₃ are coefficients determined by the physical characteristic of the laser diode 250 and the environmental factors such as temperature and undesired noise. Please note that, actually, K₂ and K₃ are constants, but K₁ is a function of temperature, i.e. K₁(T), not a constant. Because in a short time, K₁(T) is variant with temperature negligibly, so K₁(T) can be treated as a constant K₁ in a short time.

When the first loop is activated, the estimator 230 sends a first test control value to the DAC 280 through the switch 260, and the DAC 280 converts the first test control value into a first test control signal DAC_1 for controlling the driving circuit 220. Then, the driving circuit 220 drives the laser diode 250 to output a first laser beam according to the first test control signal, and the sensor 240 detects power of the first laser beam and outputs a first detecting signal sensor_1 to the ADC 285. Further, the ADC 285 converts the first detecting signal sensor_1 into a first detecting value, and transmits the first detecting value back to the estimator 230. So the relationship could be expressed as follows.
sensor_{—}1=K₁*(DAC_{—}1)+K₂*T+K₃ eq.(2)

Then, the estimator 230 sends a second test control value to the DAC 280, and the DAC 280 converts the second test control value into a second test control signal DAC_2 for controlling the driving circuit 220. Then, the driving circuit 220 drives the laser diode 250 to output a second laser beam according to the second test control signal DAC_2, and the sensor 240 detects power of the second laser beam and outputs a second detecting signal sensor_2 to the ADC 285. Further, the ADC 285 converts the second detecting signal sensor_2 into a second detecting value, and transmits the second detecting value back to the estimator 230.

Please note that because the estimator 230 sends these control signals DAC_1 and DAC_2 in a short period, the temperature variation is almost the same and negligible. The relationship could be expressed as follows.
sensor_{—}2=K₁*(DAC_{—}2)+K₂*T+K₃ eq.(3)

The estimator 230, therefore, can easily calculate the coefficient K₁ according to eq.(2) and eq.(3).

$${K}_{1} = \frac{sensor\_ 2 - sensor\_ 1}{DAC\_ 2 - DAC\_ 1} \qquad eq . ( 4 )$$

Replacing K₁ in eq.(1) by eq.(4), the detecting signal S is expressed as follows.

$$S = \frac{sensor\_ 2 - sensor\_ 1}{DAC\_ 2 - DAC\_ 1} * D + {K}_{2} * T + {K}_{3} \qquad eq . ( 5 )$$

If the operation temperature variation is ignored here, this term (K₂*T+K₃) is a fixed offset. So the detecting signal S could be further expressed as follows.

$$\begin{matrix}S = {K}_{1} * D + OFFSET \\ = \frac{sensor\_ 2 - sensor\_ 1}{DAC\_ 2 - DAC\_ 1} * D + OFFSET\end{matrix} \qquad eq . ( 6 )$$

Without considering the temperature variation, the offset of the eq.(6) can be calculated by replacing K₁ in the eq.(2) or eq.(3) by eq.(4).

$$\begin{matrix}OFFSET = sensor\_ 1 - \frac{sensor\_ 2 - sensor\_ 1}{DAC\_ 2 - DAC\_ 1} * DAC\_ 1 \\ = sensor\_ 2 - \frac{sensor\_ 2 - sensor\_ 1}{DAC\_ 2 - DAC\_ 1} * DAC\_ 2\end{matrix} \qquad eq . ( 7 )$$

The output power P is in proportion to the detecting signal S. Therefore, the output power P could be expressed as follows.
P=K₀*S=K₀*(K₁*D+OFFSET) eq.(8)

As for eq.(8), the coefficient K₀ is a fixed and given number determined by the characteristic of the sensor 240. As one can see, if the relationship between the detecting signal S and the driving signal D is known, the relationship between the output power P and the driving signal D is known accordingly.

Suppose that the temperature variation is not significant and negligible. The optical disc drive can operate according to eq.(7) with the OFFSET calculated by eq.(8). In other words, the estimator 230 directly controls output power of the laser diode 250 for accessing (reading or writing) user data according to the estimated relationship as shown in eq.(7).

The operation described above assumes that the operation temperature of the laser diode 250 keeps the same level when the laser diode 250 is working, but in the actual situation, variations of the operation temperature make the relationship between the laser power and the control value shift greatly. In this embodiment, the estimator 230 has the ability to update the relationship dynamically as the operation temperature varies. The first loop determines the relationship discussed above in a short period, therefore the temperature effect is a constant, OFFSET. But for long time operation, the temperature effect should be considered precisely. After the laser diode 250 has worked for a while, the estimator 230 sends a third test control value and the DAC 280 converts the third test control value into the third test control signal DAC_3 for a desired target power according to the relationship previously determined by DAC_1, DAC_2, sensor_1, and sensor_2. The driving circuit 220 receives DAC_3 from the DAC 280 and drives the laser diode 250 to output a laser beam accordingly. The sensor 240 detects power of the laser beam to generate a detecting signal sensor_3, and the ADC 285 converts the detecting signal sensor_3 into a detecting value back to the estimator 230. Since the coefficient K₁ doesn't change with the operation temperature, so the coefficient K₁ does not need to be updated. Because the offset includes a temperature term, the value of the offset should be updated when the operation temperature changes. Referring to eq.(1), the updated offset value (offset′) under a different operation temperature T′ is calculated by replacing K₁ in the eq.(1) by eq.(4).

$$\begin{matrix}{OFFSET}^{′} = {K}_{2} * {T}^{′} + {K}_{3} \\ = sensor\_ 3 - \frac{sensor\_ 2 - sensor\_ 1}{DAC\_ 2 - DAC\_ 1} * DAC\_ 3\end{matrix} \qquad eq . ( 9 )$$

The eq.(6) should be accordingly updated as follows.

$$\begin{matrix}S = {K}_{1} * D + {OFFSET}^{′} \\ = \frac{sensor\_ 2 - sensor\_ 1}{DAC\_ 2 - DAC\_ 1} * D + ( sensor\_ 3 - \frac{sensor\_ 2 - sensor\_ 1}{DAC\_ 2 - DAC\_ 1} * \\ DAC\_ 3 )\end{matrix}$$

As mentioned above, the output power P is in proportion to the detecting signal S. Therefore, after the relationship is updated, the output power P should be updated as follows.
P=K₀*S=K₀*(K₁*D+OFFSET′) eq.(11)

Next, paying attention on the second loop, the only difference between the first loop and the second loop included in the control system 200 is replacing the estimator 230 with the compensator 270. In fact, the second loop is similar to the conventional closed loop illustrated in FIG. 2, the rule and function of the compensator 270 are the same as the integrator 30 shown in FIG. 2 except that the compensator 270 is established by digital circuits. Usually, the compensator 270 also be utilized to reduce the response time or to stabilize the second loop.

Considering the first and second loops together, complete behavior of the control system 200 is described as follows. In the beginning, a control signal SW controls the switch 260 to connect the input port A to the output port C for transmitting an initial, digital control value outputted from the estimator 230 into the DAC 280, and the DAC 280 converts the initial control value into a initial control signal to control the driving circuit 220. The estimator 230 starts the above-mentioned steps to get the relationship between the laser power and the control value. After calculating all coefficients, the estimator 230 determines a control value according to the target power information given by the control signal Sₑ. For example, the control signal Sₑ represents an expected value for the detecting signal (e.g., FPDO signal) according to the target power. Therefore, the estimator 230 determines a control value according to the estimated relationship and the control signal Sₑ. When the operation of accessing user data is started, the output power of the laser diode 250 is controlled by the first loop in the beginning.

Then the control signal SW controls the switch 260 to connect the input port B and the output port C for allowing the compensator 270 to control the driving circuit 220. At this moment, the compensator 270, the driving circuit 220, the laser diode 250, the sensor 240, the DAC 280, and the ADC 285 form a power control loop whose operation is well-known to those skilled in this art. The compensator 270 compares the expected value provided by the control signal Sₑ and an actual value corresponding to the detecting signal generated from the sensor 240, and outputs a control value to make the driving circuit 220 adjusting the driving signal inputted into the laser diode 250. To sum up, this power control loop controls output power of the laser diode 250 to reduce the difference between the target power and output power of the laser diode 250. It is because the conventional closed-loop control adjusts output power of the laser diode 250 for all effects, not only for temperature variation. Due to the operation temperature might change significantly, the switch 260, in this embodiment, should be periodically switched to connect nodes A and C to update the coefficients.

In the normal condition, the input port B of the switch 260 is connected to the output port C, and the control system 200 acts as a related art power control loop. When output power of the laser diode 250 changes a lot, for example, a transition from a read mode to a write mode occurs, the control signal SW controls the switch 260 to connect the output port C to the input port A instead of the input port B, the estimator 230 starts determining an initial control value corresponding to a target power according to the relationship expressed in eq.(7) or eq.(10). According to the initial control value, the driving circuit 220 utilizes an initial driving signal for driving the laser diode 250 to generate a laser beam. With the help of the estimated relationship, the initial power of the laser beam is close to the target power. Then the control signal SW makes the switch 260 connecting the input port B and the output port C, and the control system 200 acts as the conventional power control loop again to activate the compensator 270 for determining a difference between the target power and initial power of the laser beam, thereby controlling power of the laser beam to reduce the difference between the target power and power of the laser beam. The embodiment combines the related art power control loop and the present invention together. Therefore, there is an obvious advantage that the response time of the control system 200 is greatly shortened owing to a minimized gap between the target power and an initial power predicted through the estimator 230.

As shown in FIG. 4, the estimator 230 and the compensator 270 are both digital circuits. Therefore, comparing with analog circuits, digital circuits is capable of correctly holding the control value even when recording operation is paused, that avoids voltage error caused by current leakage of capacitors. Although digital control is conveniently and flexibly, however, the estimator 230 and the compensator 270 are not limited to digital circuits. Furthermore, the compensator 270 could be implemented from the related art analog compensator. In addition, a temperature sensor could be added on the control system 200 for detecting the operation temperature of the laser diode 250. Coefficients of the relationship shown in eq.(10) under different temperatures are recorded into a look-up table. Therefore, when the estimator 230 receives the information of the operation temperature provided by the temperature sensor, it chooses suitable coefficients from the look-up table, which reduces the calculating time but increases the cost due to the temperature sensor.

The estimator 230 updates the relationship between output power of the laser diode 250 and the control value, and generates a corrected control value according to the updated relationship, so the control system 200 is capable of immediately and dynamically compensating for the control value in response to the temperature variation. For instance, every N ms, the input port of switch 260 is switched from B to A, and the relationship is re-estimated to update the coefficients. A more accurate relationship is therefore acquired through the above update process. After the relationship is built via eq.(10) or eq.(11), the optical disc drive utilizes the estimated relationship to control output power of the laser diode 250. That is, the estimator 230 utilizes the updated relationship as shown in eq.(10) or eq.(11) to send a control value to the following DAC 280 in order to apply a proper driving signal to driving the laser diode 250 to output a laser beam with the desired target power.

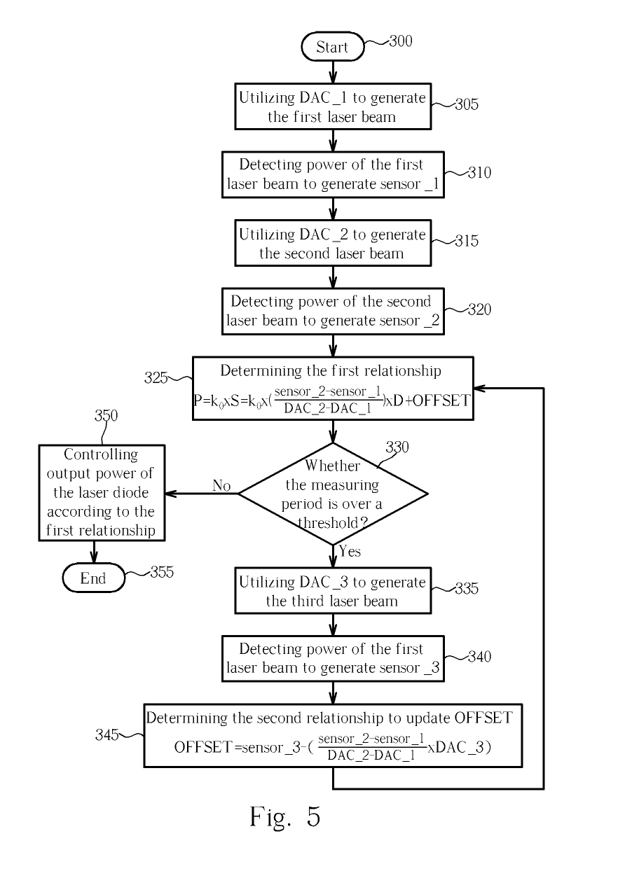

Please refer to FIG. 5. FIG. 5 is a flowchart illustrated the method to determine the first and second relationship of the embodiment disclosed in the present invention. From the description mentioned above, the key points that determine the performance of power control are the method to determine the first and second relationships. The method utilized in the embodiment is described below:

Step 300: start;

Step 305: utilizing the first test control signal DAC_1 for driving the laser diode to generate the first laser beam;

Step 310: detecting power of the first laser beam for generating the first detecting signal sensor_1;

Step 315: utilizing the second test control signal DAC_2 for driving the laser diode to generate the second laser beam;

Step 320: detecting power of the first laser beam for generating the first detecting signal sensor_2;

Step 325: determining the first relationship between output power of the laser diode and a control signal according to the first and second test control signals and the first and second detecting signals, the first relationship is

$$P = {K}_{0} * S = {K}_{0} * ( \frac{sensor\_ 2 - sensor\_ 1}{DAC\_ 2 - DAC\_ 1} * D + OFFSET ) ;$$

Step 330: checking whether the measuring period is over a threshold, if the measuring period is over the threshold, going to the step 335; if the measuring period is not over the threshold, jumping to the step 350;

Step 335: utilizing the third test control signal DAC_3 for driving the laser diode to generate the third laser beam;

Step 340: detecting power of the third laser beam for generating a third detecting signal sensor_3;

Step 345: determining the second relationship between output power of the laser diode and a control signal according to the first, second, and third test control signals and the first, second, and third detecting signals for updating the parameter OFFSET, where

$$OFFSET = sensor\_ 3 - ( \frac{sensor\_ 2 - sensor\_ 1}{DAC\_ 2 - DAC\_ 1} ) * DAC\_ 3$$

, jumping to the step 325;

Step 350: controlling output power of the laser diode according to the first relationship; and

Step 355: end.

Because in a short time, the operation temperature of the laser diode is not changed a lot, so the parameter OFFSET can be treated as a constant. Therefore, during a measuring period that is shorter than a threshold, the first relationship is not necessary to update, but if the measuring time is longer than the threshold, means that the parameter OFFSET is changed, so the first relationship has to update the parameter OFFSET.

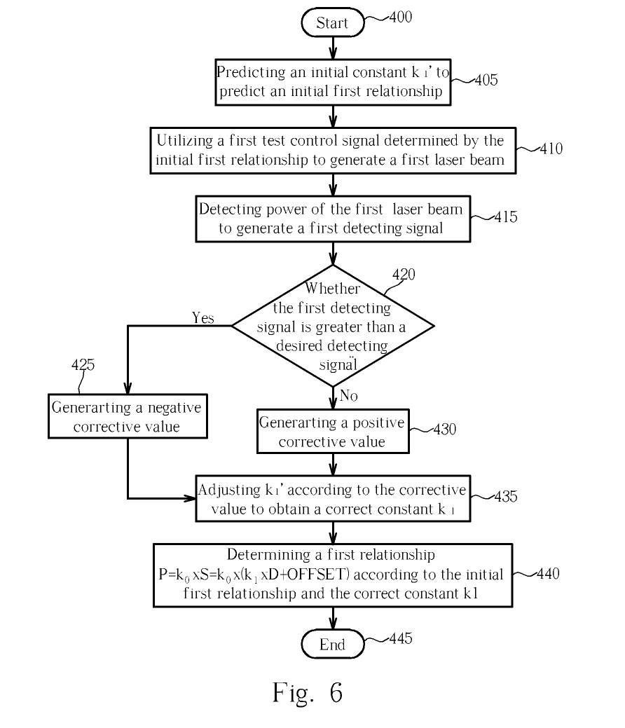

There are other methods to determine the first relationship, for example, combining a closed-loop control of the related art and the embodiment of the present invention. In the present invention, another method for obtaining the first relationship is disclosed too. This method has advantages of stability and simplicity due to the closed-loop control but also has disadvantages such as slow convergence speed. Please refer to FIG. 6. FIG. 6 is a flowchart illustrated the method to determine the first relationship of the embodiment disclosed in the present invention. Because the difference between this method and the method described above is only in the way that determines the first relationship, it is to say that the way for updating the parameter OFFSET is the same. Therefore, in FIG. 6, only steps related to the method for determining the first relationship is illustrated. The first relationship in the method is described in the form:
P=K₀*S=K₀*(K₁*D+OFFSET)

The method includes:

Step 400: start;

Step 405: predicting an initial first relationship between output power of the laser diode and a control signal;

Step 410: utilizing a first test control signal determined by the initial first relationship for driving the laser diode to generate a first laser beam;

Step 415: detecting power of the first laser beam for generating a first detecting signal;

Step 420: checking whether the first detecting signal is greater than a desired detecting signal, if the first detecting signal is greater than a desired detecting signal, going to the step 425; if the first detecting signal is not greater than the desired detecting signal, jumping to the step 430;

Step 425: generating a negative corrective value corresponding to the difference of the first detecting signal and the desired detecting signal, jumping to the step 435;

Step 430: generating a negative corrective value corresponding to the difference of the first detecting signal and the desired detecting signal;

Step 435: determining the constant K₁ via adjusting the initial constant K₁′ by the negative corrective value if the detecting signal is greater than the desired detecting signal; or by the positive corrective value if the detecting signal is not greater than the desired detecting signal;

Step 440: determining the first relationship
P=K₀*S=K₀*(K₁*D+OFFSET)

according to the initial first relationship and the constant K₁;

Step 445: end.

Because in a short time, the operation temperature of the laser diode is not changed a lot, so the parameter OFFSET can be treated as a constant. Therefore, during a measuring period that is shorter than a threshold, the first relationship is not necessary to update, but if the measuring time is longer than the threshold, the parameter OFFSET is changed, so the first relationship has to update the parameter OFFSET. The updating method is similar to the method described above, comprises utilizing a second test control signal DAC_2′ for driving the laser diode to generate a second laser beam, and detecting power of the second laser beam for generating a second detecting signal sensor_2′. The parameter OFFSET is determined by the equation:
OFFSET=sensor_{—}2′−K₁*DAC_{—}2′

And the second relationship is represented as
P=K₀*S=K₀*[K₁*D+(sensor_{—}2′−K₁*DAC_{—}2′)]

In contrast to the related art, the method and control system in the present invention estimates the relationship between the laser power and the control value. The offset due to temperature variation is fully considered. Moreover, the estimated relationship is updated dynamically and quickly to accurately compensate for the temperature variation. In addition, when the reading or writing operations for user data begin, an initial power of a laser diode is close to a target power with an initial control value predicted through the estimated relationship, which greatly reducing the response time to stabilize output power of the laser diode.

There is another advantage of the method and control system that lots of adjustments of different laser diodes are operated respectively. Taking a pick-up head in an optical disc drive for example, the pick-up head includes one laser diode for different channels such that read channels and write channels. In conventional power control method, only one or two channels have closed loops for power control, others are ignored (i.e. output a constant power). But utilizing the present invention, due to the advantages of the digital control, a correcting value obtaining in one channel according to the claimed control method is referenced by other channels. The pick-up head adjusts parameters for driving all channels respectively and automatically.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method with output power control for a laser diode, the method comprises:
(a) utilizing a first test control signal for driving the laser diode to generate a first laser beam;
(b) detecting power of the first laser beam for generating a first detecting signal;
(c) utilizing a second test control signal for driving the laser diode to generate a second laser beam;
(d) detecting power of the second laser beam for generating a second detecting signal;
(e) determining a first relationship between output power of the laser diode and a control signal according to the first and second test control signals and the first and second detecting signals; and
(f) controlling output power of the laser diode according to the first relationship.

2. The method of claim 1 wherein steps (a), (b), (c), (d) and (e) are repeated at least once for updating the first relationship.

3. The method of claim 1 wherein the first relationship is represented by
$$P = {K}_{0} * S = {K}_{0} * ( \frac{sensor\_ 2 - sensor\_ 1}{DAC\_ 2 - DAC\_ 1} * D + OFFSET )$$
, where DAC_1 and DAC_2 respectively correspond to the first and second test control signals, sensor_l and sensor_2 respectively correspond to the first and second detecting signals, P represents output power of the laser diode, D represents a driving signal, S represents a detecting signal, and K₀ and OFFSET are both constants.

4. The method of claim 1 wherein step (f) further comprises:
determining an initial control signal corresponding to target power according to the first relationship;
utilizing the initial control signal for driving the laser diode to generate a laser beam to access user data; and
activating a compensator for determining a difference between the target power and power of the laser beam, and for controlling power of the laser beam to reduce the difference between the target power and power of the laser beam.

5. The method of claim 1 wherein after the first relationship is determined, the method further comprises:
utilizing a third test control signal for driving the laser diode to generate a third laser beam;
detecting power of the third laser beam for generating a third detecting signal;
determining a second relationship according to the first relationship, the third test control signal, and the third detecting signal; and
controlling output power of the laser diode to access user data according to the second relationship.

6. The method of claim 5 wherein the first relationship is represented by
$$P = {K}_{0} * S = {K}_{0} * ( \frac{sensor\_ 2 - sensor\_ 1}{DAC\_ 2 - DAC\_ 1} * D + OFFSET )$$
, and the second relationship is represented by
$$\begin{matrix}P = {K}_{0} * S \\ = {K}_{0} * [ \frac{sensor\_ 2 - sensor\_ 1}{DAC\_ 2 - DAC\_ 1} * D + \\ ( sensor\_ 3 - \frac{sensor\_ 2 - sensor\_ 1}{DAC\_ 2 - DAC\_ 1} * DAC\_ 3 ) ]\end{matrix}$$
, where DAC_1, DAC_2 and DAC_3 respectively correspond to the first, second and third test control signals, sensor_1, sensor_2 and sensor_3 respectively correspond to the first, second and third detecting signals, P represents output power of the laser diode, D represents a driving signal, S represents a detecting signal, and K₀ and OFFSET are constants.

7. The method of claim 5 wherein the step of controlling output power of the laser diode according to the second relationship further comprises:
determining an initial control signal corresponding to target power according to the second relationship; and
utilizing the initial control signal for driving the laser diode to generate a laser beam; and
activating a compensator for determining a difference between the target power and power of the laser beam and for controlling power of the laser beam to reduce the difference between the target power and power of the laser beam.

8. The method of claim 1 wherein the laser diode belongs to a pick-up head in an optical disc drive.

9. The method of claim 8 wherein the pick-up head includes a plurality of channels and the method only controls one channel.

10. The method of claim 1 further comprising:
converting the first and second detecting signals into a first digital detecting value and a second digital detecting value, respectively;
converting a first digital control value and a second digital control value into the first and second test control signals, respectively; and
wherein the first relationship is determined according to the first and second digital control values and the first and second digital detecting values.

11. A method for output power control of a laser diode, the method comprises:
(a) predicting an initial first relationship between output power of the laser diode and a control signal;
(b) utilizing a first test control signal determined by the initial first relationship for driving the laser diode to generate a first laser beam;
(c) detecting power of the first laser beam for generating a first detecting signal;
(d) comparing the first detecting signal with a desired detecting signal to generate a corrective value;
(e) determining a first relationship between output power of the laser diode and the control signal according to the initial first relationship and the corrective value; and
(f) controlling output power of the laser diode according to the first relationship.

12. The method of claim 11 wherein steps (a), (b), (c), (d) and (e) are repeated at least once for updating the first relationship.

13. The method of claim 11 wherein the first relationship is represented by
P=K₀*S=K₀*(K₁*D+OFFSET)
, where P represents output power of the laser diode, D represents a driving signal, S represents a detecting signal, and K₀, K₁ and OFFSET are all constants.

14. The method of claim 13 wherein the step (a) further comprises:
predicting an initial constant K₁′ to predict the first initial relationship;
the step (d) further comprises:
if the first detecting signal is greater than the desired detecting signal, generating a negative corrective value corresponding to the difference of the first detecting signal and the desired detecting signal; and
if the first detecting signal is less than the desired detecting signal, generating a positive corrective value corresponding to the difference of the first detecting signal and the desired detecting signal; and
the step (e) further comprises:
determining the constant K₁ to determine the first relationship via adjusting the initial constant K₁′ by the negative corrective value if the detecting signal is greater than the desired detecting signal; or by the positive corrective value if the detecting signal is less than the desired detecting signal.

15. The method of claim 11 wherein step (f) further comprises:
determining an initial control signal corresponding to target power according to the first relationship;
utilizing the initial control signal for driving the laser diode to generate a laser beam to access user data; and
activating a compensator for determining a difference between the target power and power of the laser beam, and for controlling power of the laser beam to reduce the difference between the target power and power of the laser beam.

16. The method of claim 11 wherein after the first relationship is determined, the method further comprises:
utilizing a second test control signal for driving the laser diode to generate a second laser beam;
detecting power of the second laser beam for generating a second detecting signal;
determining a second relationship according to the first relationship, the second test control signal, and the second detecting signal; and
controlling output power of the laser diode to access user data according to the second relationship.

17. The method of claim 16 wherein the first relationship is represented by
P=K₀*S=K₀*(K₁*D+OFFSET)
, and the second relationship is represented by
P=K₀*S=K₀*[K₁*D+(sensor_{—}2′−K₁*DAC_{—}2′)]
, where DAC_2′ corresponds to the second test control signal, sensor_2′ corresponds to the second detecting signal, P represents output power of the laser diode, D represents a driving signal, S represents a detecting signal, and K₀, K₁ and OFFSET are all constants.

18. The method of claim 16 wherein the step of controlling output power of the laser diode according to the second relationship further comprises:
determining an initial control signal corresponding to target power according to the second relationship; and
utilizing the initial control signal for driving the laser diode to generate a laser beam; and
activating a compensator for determining a difference between the target power and power of the laser beam and for controlling power of the laser beam to reduce the difference between the target power and power of the laser beam.

19. The method of claim 11 wherein the laser diode belongs to a pick-up head in an optical disc drive.

20. The method of claim 19 wherein the pick-up head includes a plurality of channels and the method only controls one channel.

21. The method of claim 11 further comprising:
converting the first detecting signal into a first digital detecting value;
converting a first digital control value into the first test control signal; and
wherein the corrective value is determined according to the first digital detecting value and a desired detecting value.

22. A control system with output power control for a laser diode, the control system comprises:
a driving circuit electrically connected to the laser diode for driving the laser diode to generate a first laser beam according to a first test control signal and driving the laser diode to generate a second laser beam according to a second test control signal;
a sensor for detecting power of the first laser beam to generate a first detecting signal and detecting power of the second laser beam to generate a second detecting signal; and
an estimator electrically connected to the sensor and the driving circuit for determining the first and second test control signals, determining a first relationship between output power of the laser diode and a control signal according to the first and second test control signals and the first and second detecting signals, and controlling output power of the laser diode according to the first relationship.

23. The control system of claim 22 wherein the estimator updates the first relationship at least once.

24. The control system of claim 22 wherein the first relationship is represented by
$$P = {K}_{0} * S = {K}_{0} * ( \frac{sensor\_ 2 - sensor\_ 1}{DAC\_ 2 - DAC\_ 1} * D + OFFSET )$$
, where DAC_1 and DAC_2 respectively correspond to the first and second test control signals, sensor_1 and sensor_2 respectively correspond to the first and second detecting signals, P represents output power of the laser diode, D represents a driving signal, S represents a detecting signal, and K₀ and OFFSET are both constants.

25. The control system of claim 22 wherein the estimator further determines an initial control signal corresponding to target power according to the first relationship, for driving the laser diode to generate a laser beam to access user data; and the control system further comprises:
a compensator electrically connected to the driving circuit for determining a difference between the target power and power of the laser beam, and controlling power of the laser beam to reduce the difference between the target power and power of the laser beam.

26. The control system of claim 22 wherein after the estimator determines the first relationship, the sensor further detects power of a third laser beam for generating a third detecting signal; and the estimator further determines a third test control signal for driving the laser diode to generate the third laser beam, determines a second relationship according to the first relationship, the third test control signal, and the third detecting signal, and controls output power of the laser diode to access user data according to the second relationship.

27. The control system of claim 26 wherein the first relationship is represented by
$$P = {K}_{0} * S = {K}_{0} * ( \frac{sensor\_ 2 - sensor\_ 1}{DAC\_ 2 - DAC\_ 1} * D + OFFSET )$$
, and the second relationship is represented by
$$\begin{matrix}P = {K}_{0} * S \\ = {K}_{0} * [ \frac{sensor\_ 2 - sensor\_ 1}{DAC\_ 2 - DAC\_ 1} * D + \\ ( sensor\_ 3 - \frac{sensor\_ 2 - sensor\_ 1}{DAC\_ 2 - DAC\_ 1} * DAC\_ 3 ) ]\end{matrix}$$
, where DAC_1, DAC_2 and DAC_3 respectively correspond to the first, second and third test control signals, sensor_1, sensor_2 and sensor_3 respectively correspond to the first, second and third detecting signals, P represents output power of the laser diode, D represents a driving signal, S represents a detecting signal, and K₀ and OFFSET are constants.

28. The control system of claim 26 wherein the estimator further determines an initial control signal corresponding to target power according to the second relationship, for driving the laser diode to generate a laser beam; and the control system further comprises:
a compensator electrically connected to the driving circuit for determining a difference between the target power and power of the laser beam, and controlling power of the laser beam to reduce the difference between the target power and power of the laser beam.

29. The control system of claim 22 wherein the laser diode belongs to a pick-up head in an optical disc drive.

30. The control system of claim 29 wherein the pick-up head includes a plurality of channels.

31. The control system of claim 22 further comprising:
an analog-to-digital converter (ADC) electrically connected to the sensor and the estimator for converting the first and second detecting signal into a first digital detecting value and a second digital detecting value, respectively; and
a digital-to-analog converter (DAC) electrically connected to the estimator for converting a first digital control value and a second digital control value into the first and second test control signals, respectively;
wherein the estimator determines the first relationship according to the first and second
digital control values and the first and second digital detecting values.
